(19) United States
(12) Patent Application Publication
(10) Pub. No.: US 2022/0251371 A1
(43) Pub. Date: Aug. 11, 2022

(54) BIOMASS-CONTAINING PLASTIC COMPOSITION AND PREPARATION PROCESS THEREOF

(71) Applicant: PTT PUBLIC COMPANY LIMITED, Chatuchak, Bangkok (TH)

(72) Inventors: Jirawut JUNKASEM, Bangkok (TH); Narin KAABBUATHONG, Bangkok (TH); Supatra HEMMUT, Bangkok (TH); Vivan THAMMONGKOL, Bangkok (TH)

(21) Appl. No.: 17/613,539

(22) PCT Filed: Nov. 15, 2019
(86) PCT No.: PCT/TH2019/000061

§ 371 Date: Nov. 23, 2021

(30) Foreign Application Priority Data
Jul. 31, 2019 (TH) 1903001947

(51) Int. Cl. C08L 67/02

(52) U.S. Cl. CPC C08L 67/02

(57) ABSTRACT

The present invention relates to a biomass-containing plastic composition comprising: (i) a plastic precursor which is el selected from one or more of bioplastic or conventional plastic or plastic blend thereof; (ii) a biomass which is a biomass byproduct deriving from a coffee roasting process such as: coffee chaff; (iii) a friction reducing agent such as: fluoro polymer or fluoro polymer derivatives; and (iv) an inorganic compound in carbonate form of group 2 of the periodic table. Furthermore, this invention also relates to the preparation process of said biomass-containing plastic composition for molding into various bioplastic products for various applications.

### TECHNICAL FIELD OF THE INVENTION

The present invention relates to biomass-containing plastic composition and preparation process thereof.

### BACKGROUND OF THE INVENTION

In recent years, the whole world has been focusing more on bioplastic or biodegradable plastic in green policy, research and development, related industries and the production of molded products to support and promote the use of bioplastic to replace general plastics, of which are difficult to decompose, or non-biodegradable plastics. Such interest is evident from, for example, in the United States, the goal of using biomass products increased from the original amount of 5% by weight in 2002 to 12% by weight in 2010 and likely to increase to 20% by weight in 2030. In the European Union, the manufacturing of cars must consist of parts that can be reused or recovered of no less than 85% by weight before 1 Jan. 2006.

Research and development (R&D) of plastic compositions by using biomass as a component to obtain bioplastics is one method to develop plastics that are for environmental protection use in terms of raw materials, production processes and removal processes, that have been disclosed in many patented documents. These documents refer to the biomass-containing plastic compositions and the process for preparing the same, including their applications. They consist of various steps in order to obtain the bioplastic products as desired. The biomass-containing plastic compositions provide the same characteristics as equivalent to conventional plastics derived from the traditional petrochemical industry (commodity plastic), such as various density polyethylene (for example LDPE, HDPE), poly(vinyl chloride) (PVC) and can be used to replace the use of those conventional plastics as disclosed in the following prior arts.

Prior art 1, US Patent Application No. US20170107334A1 titled “RENEWABLE REPLACEMENTS FOR CARBON BLACK IN COMPOSITES AND METHODS OF MAKING AND USING THEREOF” disclosed biomass-containing plastic compositions and processes for manufacturing said compositions. The biomass-containing plastic compositions comprise of resin 25 to 75% by weight and elemental carbon derived from pyrolyzed biomass 25 to 75% by weight.

Prior art 2, Korean Patent Application No. KR2018132763A titled “CELLULOSIC COMPOSITES COMPRISING WOOD PULP” disclosed composition of composite material comprised of polymer mixed with paper pulp biomass in the amount of 5 to 35% by weight and inorganic compound modifier in the amount of 1 to 90% by weight.

Prior art 3, US Patent Application No. US20180142073A1 titled “BIODECOMPOSABLE FILM MATERIAL AND METHOD FOR MAKING THE SAME” disclosed a film plastic composition comprised of biodegradable polymer in the amount of 60 to 70% by weight mixed with biomass being selected from wastes from food and agricultural industries in the amount of 10 to 30% by weight in combination with an inorganic compound modifier in the amount of 7 to 29% by weight.

Prior art 4, European Patent Application No. EP3265515A4 titled “BIODEGRADABLE POLYMER-BASED BIOCOMPOSITES WITH TAILORED PROPERTIES AND METHOD OF MAKING THOSE” discloses biodegradable polymers consisting of biomass being selected from spent coffee or agricultural wastes or wastes from ethanol production process in the amount of not more than 50% by weight in combination with a compatibilizer containing anhydride group (—C(O)—O—C(O)—).

From the prior arts recited above, it can be seen that there is a continuous development for plastic composition by using biomass such as: coffee ground, paper, or bark as one of the main components. This is to reduce costs and environmental footprint by using byproducts from biomass to maximize benefits and/or to improve the plastics to have biodegradable properties and various characteristics to be molded into the final product for a variety of applications.

The present invention is directed to coffee byproducts derived from a coffee roasting process, which is a type of biomass that can be used as a plastic component. Notably, there has been an increase in coffee consumption every year, in which resulting in an increased demand for roasted coffee beans. As a result, coffee roasting processes with a capacity of 1,800 tons per year will produce various types of biomass byproducts, such as, coffee ground and coffee chaff, which are 8.8 tons of the coffee chaff per year.

Therefore, the present invention is directed to the use of coffee chaff byproduct, which derived from said coffee roasting process as a plastic component, which provides distinctive feature as a biodegradable plastic. The biodegradable plastic exhibits a texture similar to natural materials and has mechanical properties including the melt flow property of polymers that are found to be suitable for molding into a final product for various uses.

### SUMMARY OF THE INVENTION

The present invention relates to biomass-containing plastic composition comprising (i) plastic precursor being selected from one or more of bioplastic or conventional plastic or plastic blend thereof in the amount of 55 to 85% by weight; (ii) biomass, which is biomass byproducts from the coffee roasting process such as coffee chaff in the amount of 5 to 25% by weight; (iii) friction reducing agent comprising of fluoro polymer or fluoro polymer derivatives in the amount of 0.1 to 5% by weight; and (iv) inorganic compound in carbonate form of group 2 of the periodic table in the amount of 5 to 20% by weight.

The objective of the present invention is to provide the biomass-containing plastic composition and its preparation process thereof, which is a sub-bioplastic to be molded into various bioplastic products for various applications. The final bioplastic products provide the appearance and texture of natural materials through an extrusion, injection, compression and thermoforming or injection molding processes in the industrial scale.

### DETAILED DESCRIPTION OF EMBODIMENTS OF THE INVENTION

### Definitions

The term “bioplastic” as used herein refers to plastics made from biomass raw materials that have biodegradable properties. As such, it is used interchangeably with the term “biodegradable plastic”.

The term “plastic composition” as used herein refers to plastics that are manufactured by a combination of various components consisting of plastics being selected from one or more of plastics and other additives. As such, it can be used interchangeably with the term “plastic blend composition”.

The present invention relates to a development of biomass-containing plastic composition and its preparation process thereof, wherein biomass according to the present invention is coffee chaff, a biomass byproduct deriving from the coffee roasting process.

Biomass-containing plastic composition according to the present invention comprises of:

(i) plastic precursor being selected from one or more of bioplastic or conventional plastic or plastic blend thereof in the amount of 55 to 85% by weight of the plastic composition;

(ii) biomass being selected from biomass byproduct deriving from the coffee roasting process such as coffee chaff in the amount of 5 to 25% by weight of the plastic composition;

(iii) friction reducing agent such as: fluoro polymer or fluoro polymer derivatives in the amount of 0.1 to 5% by weight of the plastic composition; and

(iv) inorganic compound in carbonate form of group 2 of the periodic table in the amount of 5 to 20% by weight of the plastic composition.

According to the present invention, The type of bioplastic can be selected from poly(lactic acid) (PLA), poly(butylene succinate) (PBS), poly(butylene succinate-co-adipate) (PB SA) or poly(butylene adipate-co-terephthalate) (PB AT), etc. and conventional plastic can be selected from polyolefin, poly(styrene), poly(amide) or acrylonitrile-co-butadiene-co-styrene.

According to the embodiment of the present invention, suitable plastic precursor is poly (butylene succinate) in the amount of 35 to 50% by weight of the plastic composition, which provides the suitable flow index of the plastic composition according to the present invention for molding by injection process.

According to the embodiment of the present invention, another suitable plastic precursor is poly (lactic acid) in the amount of 20 to 35% by weight of the plastic composition, which provides strength to the resulting plastic composition according to the present invention.

According to the embodiment of the present invention, plastic precursor is plastic blend of poly(butylene succinate) and poly(lactic acid) in the amount of 55 to 85% by weight of the plastic composition.

According to the embodiment of the present invention, biomass from the coffee roasting process such as coffee chaff in the amount of 5 to 25% by weight of the plastic composition, which results in the final molded plastic product having surface texture resembling natural materials.

According to the embodiment of the present invention, friction reducing agent can be selected from at least one of fluoro polymer or fluoro polymer derivatives in the amount of 0. 1-5% by weight, which results in an improved bioplastic component flow and found to be suitable for molding into final plastic products.

According to the embodiment of the present invention, suitable inorganic compound in carbonate form of group 2 of the periodic table is calcium carbonate compound in the amount of 5-20% by weight of the plastic composition, which results in faster cooling of the bioplastic compositions and found to be suitable for the molding. Additionally, the compositions also exhibited increased strength for the final plastic products.

According to the embodiment of the present invention, plastic composition containing biomass from the coffee roasting process, including coffee chaff as composition, according to the present invention is suitable for injection molding of final plastic products to obtain the final plastic products that have surface texture resembling of natural materials.

The preparation process of plastic composition containing biomass deriving from coffee roasting process as component according to the present invention, consisting of two main steps:

a. Preparation steps of plastic composition comprising the following sub-steps:
(i) mixing of plastic precursor being selected from one or more of bioplastic or conventional plastic or plastic blend thereof with biomass being selected from biomass byproduct deriving from coffee roasting process such as coffee chaff, friction reducing agent such as: fluoro polymer or fluoro polymer derivatives and inorganic compound in carbonate form of group 2 of the periodic table to obtain a plastic blend composition;
(ii) cutting the plastic blend composition obtained from step a(i) into pellets and storing of the said plastic composition pellets; and
(iii) drying the plastic blend composition pellets obtained from step a(ii)

b. Molding steps of the final plastic product from plastic blend composition obtained from step a comprising of the following sub-steps:
(i) feeding the plastic blend composition pellets obtained from step a. into the injection molding machine; and
(ii) molding injection with the said injection molding machine to obtain final plastic product that has surface texture resembling of natural materials.

According to the embodiment of the present invention, the mixing process of plastic precursor with biomass, friction reducing agent and inorganic compound according to the present invention is perform by using a mixer, of which causes an evenly distribution and uniformly mix the said components before proceeding to the next step.

According to the embodiment of the present invention, the suitable mixer is a twin screw extruder. The above mixing is performed by feeding all components separately into two portions. The first portion consisting of plastic precursor is fed into the main feeder. The second portion consisting of biomass, friction reducing agent and inorganic compound according to the present invention are fed to the side feeder. By feeding the two portions separately, this provides a more accurately control process for the content of the second portion.

According to the embodiment of the present invention, as appropriate, the mixing process using the twin screw extruder, in which the parameter specified set including the temperature of the twin screw extruder 150 to 210° C. and the screw speed 100 to 400 rpm. The specified set parameter of twin-screw extruder results in complete melting of plastic blend composition pellets and reduce the likelihood of unwanted adverse reactions such as: hydrolysis and thermal degradation.

According to the embodiment of the present invention, the plastic blend composition pellets, obtained from step a(ii), can be dried by commonly known methods such as: baking, which removes moisture from the plastic blend composition pellets at 60 to 80° C. for at least 4 hours, which appropriately reduces the moisture in the plastic blend composition pellets to only 2 to 5% by weight. This method reduces the chance of unwanted side reactions such as: hydrolysis or thermal degradation. This process also acts as a quality control of the plastic composition obtained from each preparation and found to extend the storage life of the plastic composition obtained according to the present invention. In addition, drying of said plastic composition can also be achieved by baking under vacuum to shorten the process or reduces the drying temperature needed.

According to the embodiment of the present invention, as appropriate, in the process of molding the final plastic product, the process of feeding the plastic blend composition pellets obtained from step a. into the injection molding machine in which the parameter specified set including injection molding temperature 150 to 250° C., injection speed 10 to 100 cm³/sec, injection pressure 1000-2200 bar, mold temperature 20 to 50° C. and cooling time 2 to 10 sec. The specified setting of the injection molding machine provides a continuous production of bioplastic products and the duration of production in each of bioplastic products is similar to a typical commercial production wherein bioplastic products exhibit excellent quality, also exhibiting surface texture resembling of natural materials and low yield of defects.

According to the embodiment of the present invention, preferably, the molding process is an injection molding process to obtain a bioplastic product with surface texture resembling of natural materials.

According to the embodiment of the present invention, biomass-containing plastic composition and preparation process of plastic composition that can produce bioplastic to be used in the manufacturing of various final plastic products. The said final plastic products exhibit the appearance and surface texture resembling of natural materials via the extrusion process, injection process, compression process, thermoforming process or injection molding process in the industrial scale.

It should be realized by those who are skilled in the art that any variations and combinations of the process as described above, which may be optional or may be included should be considered as known facts and common knowledge. All of which, are to be considered as within the scope of the intended invention.

### Example

The examples herein are for the preparation process of plastic composition containing biomass deriving from coffee roasting process for the injection molding of bioplastic product that provides surface texture resembling natural materials. The formula of said plastic composition is presented in Table 1, which detailed the preparation process of the composition as follows:
1. Washed coffee chaff with water acting as solvent at the temperature of 60 to 80° C. for at least 4 hours, then dry the washed chaff by commonly known methods wherein the washed and dried coffee chaff should have moisture content not exceed 3% by weight
2. Weighted the components as required in Table 1 by mixing the components together with a dry mixing machine, then take all the plastic composition into the feeder of the twin screw extruder by feeding separately, the plastic components are fed to the main feeder and additive parts feed into the secondary feeder in which the twin screw extruder is set as specified above, including the temperature of the twin screw extruder 180 to 200° C., the screw speed of 100 to 300 rpm and the pellet feeding rate of 1 to 5 kg/hour. Then, the obtained plastic blend composition is cooled by running through water and then forming into pellets by a plastic pelletizer.
3. Dried the plastic blend composition pellet using the dryer to remove water at temperature of 60 to 80° C. for at least 4 hours and take the resulting plastic blend composition pellets to test for the melt flow rate (MFR) with a flow meter.
4. Injected the obtained plastic blend composition pellets into a test piece according to international standard (ASTM) by injection molding machine wherein the injection molding machine is set as injection molding temperature: 150 to 250° C., injection speed 10 to 100 cm³/sec, injection pressure 1000 to 2200 bar, mold temperature 20 to 50° C. and cooling time 2 to 10 sec.
5. Stored the test piece in the temperature and humidity control cabinet at the storage temperature of 21 to 25° C. and relative humidity 45 to 55% for at least 40 hours.
6. Tested the test piece for the properties such as mechanical properties, melt flow index of polymers and color values, etc. The properties of the test piece are as shown in Table 2.
   Table 1 shows the resulting bioplastic blend composition according to the present invention

| | % by weight | | | | |
|---|---|---|---|---|---|
| | Poly(butylene | Poly(lactic | | | Friction |
| Test | succinate) | acid) | Coffee | Calcium | reducing |
| piece | (PBS) | (PLA) | chaff | carbonate | agent |
| A | 42.0 | 28.0 | 20.0 | 10.0 | 0.1 |
| B | 41.6 | 27.7 | 19.8 | 9.9 | 1.0 |
| C | 40.8 | 27.2 | 19.4 | 9.7 | 2.9 |
| D | 44.6 | 29.7 | 19.8 | 5.0 | 1.0 |
| E | 35.6 | 23.8 | 19.8 | 19.8 | 1.0 |
| F | 47.5 | 31.7 | 9.9 | 9.9 | 1.0 |

Table 2 shows properties of the plastic blend composition

| | | | | | | Heat Distortion |
|---|---|---|---|---|---|---|
| Test | Molding | Melt flow ability | Flexural Modulus | Flexural strength | Impact Strength | Temperature |
| piece | ability | (g/10 min) | (MPa) | (MPa) | (KJ/m²) | (° C.) |
| A | Good | 17.6 ± 0.3 | 2,606 ± 47 | 56 ± 1 | 3.0 ± 0.3 | 85.0 ± 1.4 |
| B | Excellent | 17.9 ± 0.6 | 2,513 ± 29 | 54 ± 1 | 3.8 ± 0.7 | 91.8 ± 1.7 |
| C | Excellent | 18.8 ± 0.2 | 2,343 ± 47 | 49 ± 1 | 4.0 ± 0.6 | 82.4 ± 9.0 |
| D | Excellent | 20.6 ± 0.3 | 2,372 ± 34 | 54 ± 1 | 3.9 ± 0.5 | 83.5 ± 2.9 |
| E | Good | 16.0 ± 0.2 | 2,843 ± 54 | 50 ± 1 | 3.0 ± 0.4 | 89.2 ± 0.7 |
| F | Excellent | 24.5 ± 0.1 | 2,089 ± 31 | 57 ± 1 | 4.2 ± 0.3 | 74.1 ± 3.6 |

In conventional plastic molding injection, the melt flow ability is approximately 5-30 g/10 min. The results in Table 2 exhibited that the coffee chaff-containing plastic composition in Tables 1 and 2 show a melt flow ability in the range of 10-30 g/10 min, which is preferred in a various plastic injection applications. In addition, when considering the flexural modulus from Table 2, it was discovered that when the content of coffee chaff is increased in the plastic blend composition, flexural modulus is also increased.

Therefore, the present invention provides plastic composition containing biomass from coffee roasting process, including coffee chaff, as well as the process for preparation of said plastic blend, which can produce various biodegradable products using existing common molding machines without the need to modify the injection molding machine. According to the present invention, the final plastic products exhibited outstanding features, which are: biodegradable, possessing high mechanical properties with an appearance and surface texture resembling of natural materials and such.

Specification of characteristics may be combined in preferable manner without leaving the intended scope of the present invention. However, other forms of the invention may be intended as unique to a particular characteristic or specific combination of each of them.

The above description of the characteristics of the invention is illustrated as an example. This document is not intended to be comprehensive explanation or to restrict the invention in any means and any modifications and variations may be made possible in the terms described above.

### THE BEST MODE OF THE INVENTION

As was mentioned in the full disclosure of the invention.

1. A biomass-containing plastic composition comprising: (i) a plastic precursor, (ii) a biomass, (iii) a friction reducing agent and (iv) an inorganic compound, wherein:
(i) the plastic precursor being selected from one or more of bioplastic or conventional plastic or plastic blend thereof in an amount of 55 to 85% by weight of the plastic composition;
(ii) the biomass being selected from biomass byproduct from a coffee roasting process in the amount of 5 to 25% by weight of the plastic composition;
(iii) the friction reducing agents are fluoro polymer or fluoro polymer derivatives in the amount of 0.1 to 5% by weight of the plastic composition; and
(iv) the inorganic compound in carbonate form of group 2 of the periodic table in the amount of 5 to 20% by weight of the plastic composition.

2. The plastic composition according to claim 1, wherein the plastic precursor is one or more of bioplastic or plastic blend thereof which is selected from poly(lactic acid), poly(butylene succinate), poly(butylene succinate-co-adipate) or poly(butylene adipate-co-terephthalate).

3. The plastic composition according to claim 1, the plastic precursor comprises of poly(butylene succinate) in the amount of 35 to 50% by weight of the plastic composition.

4. The plastic composition according to claim 1, the plastic precursor comprises of poly(lactic acid) in the amount of 20-3 5% by weight of the plastic composition.

5. The plastic composition according to claim 1, wherein the plastic precursor is the polymer blend of poly(butylene succinate) and poly(lactic acid) in the amount of 55 to 85% by weight of the plastic composition.

6. The plastic composition according to claim 1, wherein the biomass byproduct from the coffee roasting process is coffee chaff.

7. The plastic composition according to claim 1, wherein the inorganic compound in carbonate form of group 2 of the periodic table is calcium carbonate compound.

8. A preparation process of the biomass-containing plastic composition according to claim 1, wherein the process comprises of the following steps:
i. washing the biomass and drying it before mixing;
ii. mixing the plastic substrate with the biomass, the friction reducing agent of fluoro polymer or fluoro polymer derivatives and the inorganic compound in carbonate form of group 2 of the periodic table to obtain a plastic blend composition;
iii. cutting the plastic blend composition into a pellet form and storing said plastic composition pellet; and
iv. drying the plastic blend composition pellet.

9. The process according to claim 8, wherein the dried biomass has a moisture content of not more than 3% by weight.

10. The process according to claim 8, wherein the dried plastic blend composition pellet has a moisture content of about 2 to 5% by weight.
